(19) United States
(12) Patent Application Publication
(10) Pub. No.: US 2006/0111144 A1
(43) Pub. Date: May 25, 2006

(54) Communication apparatus and communication method

(75) Inventor: Nobuyasu Nakajima, Kawasaki-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/281,415

(22) Filed: Nov. 18, 2005

(30) Foreign Application Priority Data
Nov. 25, 2004 (JP) 2004-340878

(51) Int. Cl. H04M 1/00

(52) U.S. Cl. 455/556.1

(57) ABSTRACT

According to this invention, a communication apparatus includes a communication unit which communicates with an external device, a management unit which manages a transmission condition of presence information, and a control unit which controls transmission of the presence information via the communication unit on the basis of the transmission condition of the presence information managed by the management unit.

### CROSS-REFERENCE TO RELATED APPLICATIONS

This application is based upon and claims the benefit of priority from prior Japanese Patent Application No. 2004-340878, filed Nov. 25, 2004, the entire contents of which are incorporated herein by reference.

### BACKGROUND OF THE INVENTION

1. Field of the Invention

The present invention relates to a consumer device such as a TV with a communication function, like a videophone. The present invention also relates to a communication method in such a consumer device.

2. Description of the Related Art

In a personal computer (to be referred to as a PC hereinafter), software for implementing a videophone function is sometimes incorporated. For example, in Windows (registered trademark) available from Microsoft, software called “Windows Messenger” (registered trademark) for implementing a videophone function is incorporated. This software registers the name of a user who activates this software on the state of this user with a server. The user state is, e.g., “present”, “absent”, or “busy”. Depending on this user state, it can be determined whether the user can answer an incoming videophone call.

When using Windows Messenger, upon activation of this software and logon by a specific user name, the event that Windows Messenger is used by the specific user name is automatically notified to the server. The change of the user state can also be automatically registered at the same time a function such as a PC screen saver starts. Furthermore, the change of the user state can also be registered in accordance with an explicit software operation by the user.

Jpn. Pat. Appln. KOKAI Publication No. 2003-319355 discloses a technique in which when a caller cannot be connected to a callee in a videophone system, a message is transmitted from the caller to the server, and the server notifies a callee of the reception of an automatically recorded message by mail.

Jpn. Pat. Appln. KOKAI Publication No. 2000-115371 discloses a technique in which a switch has a number of modes of functions, e.g., voice mail, and has a number of modes including an absence mode and an transfer mode. Functions are set beforehand in order that a function is selected and activated when a telephone number of incoming call and a callee's mode correspond to a specific telephone number and a specific callee's mode, respectively.

Jpn. Pat. Appln. KOKAI Publication No. 9-135437 discloses a technique in which a receiver with a communication function is connected to a response server via a telephone line to avoid a mismatch between the telephone number managed by the response server and that of the receiver.

However, in the above disclosed techniques, transmission of presence information cannot be controlled. That is, the user cannot control whether to notify the communication party of the presence of the device managed by the user. This is a problem from the viewpoint of privacy protection.

### BRIEF SUMMARY OF THE INVENTION

According to an aspect of the present invention, a communication apparatus comprises a communication unit configured to communicate with an external device, a management unit configured to manage a transmission condition of presence information, and a control unit configured to control transmission of the presence information via the communication unit on the basis of the transmission condition of the presence information managed by the management unit.

According to another aspect of the present invention, a communication method comprises managing a transmission condition of presence information, and controlling a transmission of the presence information on the basis of the transmission condition of the managed presence information.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate an embodiment of the invention, and together with the general description given above and the detailed description of the embodiment given below, serve to explain the principles of the invention.

FIG. 1 is a block diagram showing a system in which a communication device A is connected to a network according to an embodiment of the present invention;

FIG. 2 is a block diagram showing an example of a schematic arrangement of the communication device A for easily implementing transmission control of presence information;

FIG. 3 is a block diagram showing an example of a schematic arrangement of the communication device A for easily implementing transmission control of the presence information using a remote controller;

FIG. 4 is a block diagram showing an example of a system in which the communication device A directly uploads the presence information and status information to a communication device B;

FIG. 5 is a block diagram showing an example of a state in which the communication device B which intends to communicate with the communication device A directly inquires the communication device A of the presence information and status information;

FIG. 6 is a block diagram showing the first example of a schematic arrangement of the communication device A;

FIG. 7 is a view showing an example of the operation of the communication device A in the first example;

FIG. 8 is a block diagram showing the second example of the schematic arrangement of the communication device A;

FIG. 9 is a block diagram showing the third example of the schematic arrangement of the communication device A;

FIG. 10 is a block diagram showing the fourth example of the schematic arrangement of the communication device A;

FIG. 11 is a block diagram showing the fifth example of the schematic arrangement of the communication device A;

FIG. 12 is a block diagram showing the sixth example of the schematic arrangement of the communication device A;

FIG. 13 is a block diagram showing the seventh example of the schematic arrangement of the communication device A;

FIG. 14 is a block diagram showing the eighth example of the schematic arrangement of the communication device A;

FIG. 15 is a block diagram for explaining the first example of an editing process of a presence policy;

FIG. 16 is a block diagram for explaining the second example of the editing process of the presence policy; and

FIG. 17 is a table showing an example of a presence policy table held by a presence policy holding unit.

### DETAILED DESCRIPTION OF THE INVENTION

An embodiment of the present invention will be described below with reference to the accompanying drawings.

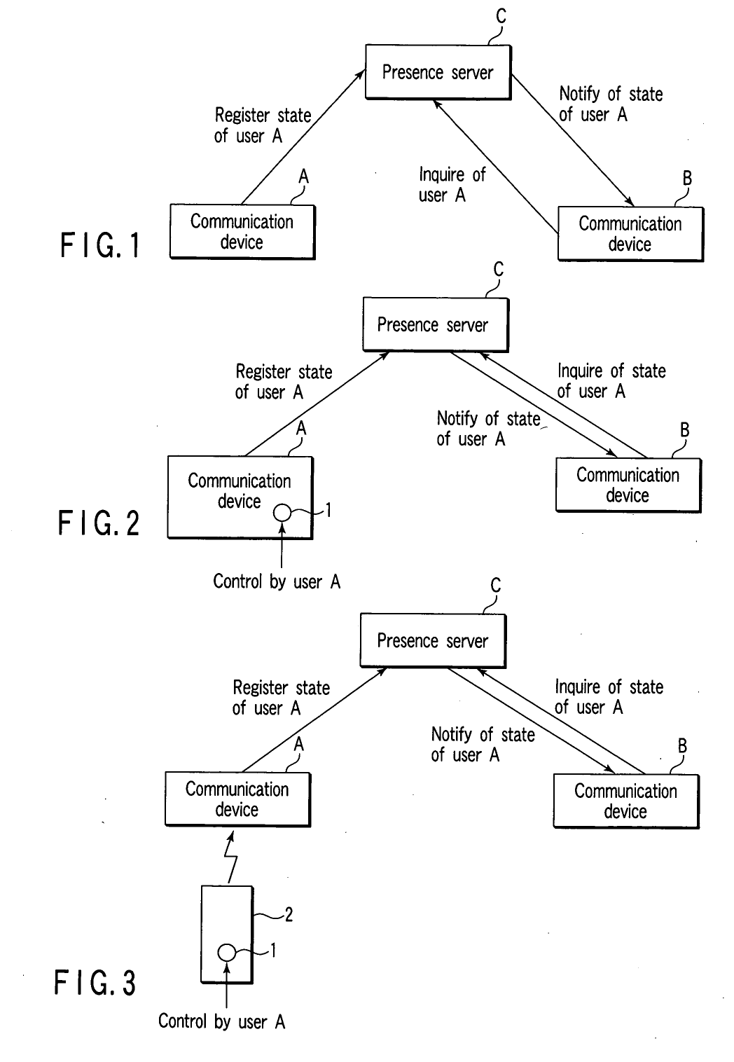

FIG. 1 is a block diagram showing a system in which a communication device A is connected to a network according to the embodiment of the present invention. As shown in FIG. 1, the communication device A managed by a user A is connected to a presence server C via the network, and a communication device B managed by a user B is also connected to the presence server C via the network.

The communication device A is a TV with a communication function like a videophone. Note that the present invention is not limited to the TV with the communication function. For example, the present invention can be applied to a system in which a communication device and a server can mutually recognize their presence by exchanging a logical message.

The communication device A includes a communication means for communicating with an external device, a management means for managing a transmission condition of the presence information of the communication device A and a transmission condition of the status information of the user A who manages and uses the communication device A, and a control means for controlling transmission of the presence information and the status information via the communication means on the basis of the transmission condition of the presence information and the status information managed by this management means. Detailed examples of the means will be described below with reference to the accompanying drawings.

For example, the management means manages the transmission condition set by the user A. This management means can set whether to transmit the presence information and the status information, depending on the presence server and a callee's device, which is the communication device B. More specifically, the management means controls transmissions of the presence information and the status information by registering with the callee's device to which the presence information and the status information are to be transmitted.

Hence, the user A can take an initiative to control transmissions of the presence information and the status information. That is, the user A can prevent the presence information and the status information from being unconditionally transmitted. In other words, the presence of the communication device A can be hidden according to a user's intention, thereby protecting privacy. For example, when the presence of the communication device A is hidden, it is effective as a measure against unsolicited bulk mails, which are mails transmitted to mail addresses selected at random.

The communication device A also includes an indicator, e.g., LED, or another display different from a video display, indicating the state in which the presence information and the status information are to be transmitted. Alternatively, the communication device A may display, by superimposing on the video display, the information indicating that the presence information and the status information are to be transmitted.

As shown in FIG. 2, the communication device A has a control button 1 which controls transmissions of the presence information and the status information. By using the control button 1, transmissions of the presence information and the status information can be easily controlled. More specifically, by using the control button 1, the presence information and the status information can be transmitted to the presence server or the registered callee's device, and the notified presence information and the status information can be deleted.

Alternatively, as shown in FIG. 3, the communication device A includes a remote controller 2 having the control button 1 which controls transmissions of the presence information and the status information. By using the control button 1 of the remote controller 2, transmissions of the presence information and the status information can be easily controlled.

The control means of the communication device A uploads the presence information and the status information to the presence server C under the transmission condition of the presence information and the status information. The communication device B which intends to communicate with the communication device A interrogates the presence server C, about the presence information and the status information of the user A.

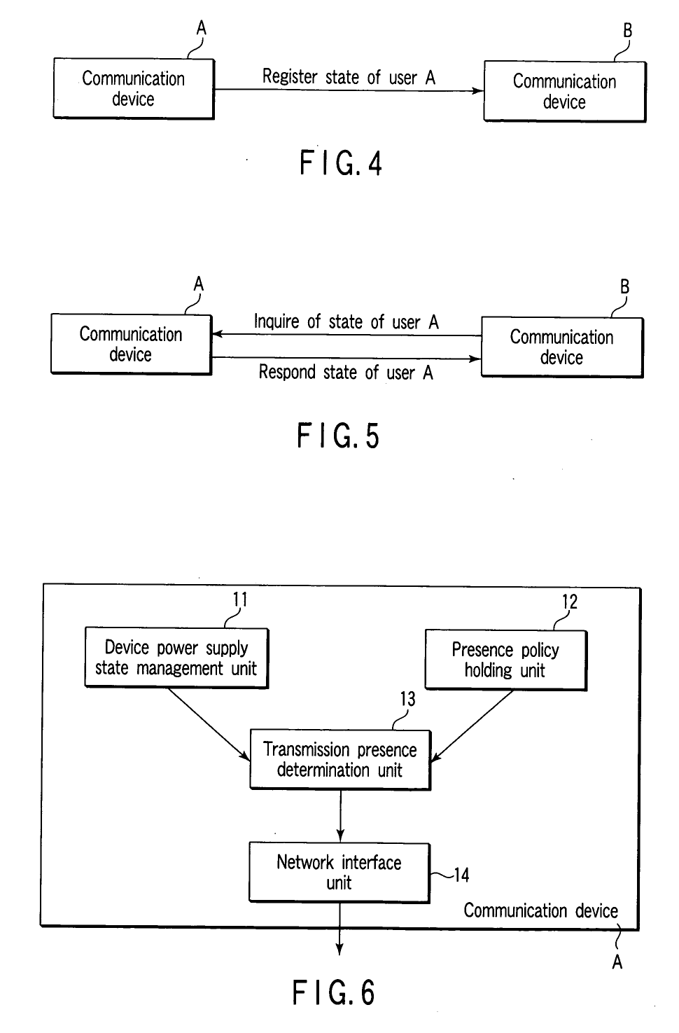

FIG. 4 is a block diagram showing a system in which the communication device A directly uploads the presence information and the status information to the communication device B. FIG. 5 is a block diagram showing a state in which the communication device B which intends to communicate with the communication device A directly interrogates the communication device A about the presence information and the status information. Upon reception of the inquiry from the communication device B, the communication device A directly notifies the communication device B of the presence information and status information.

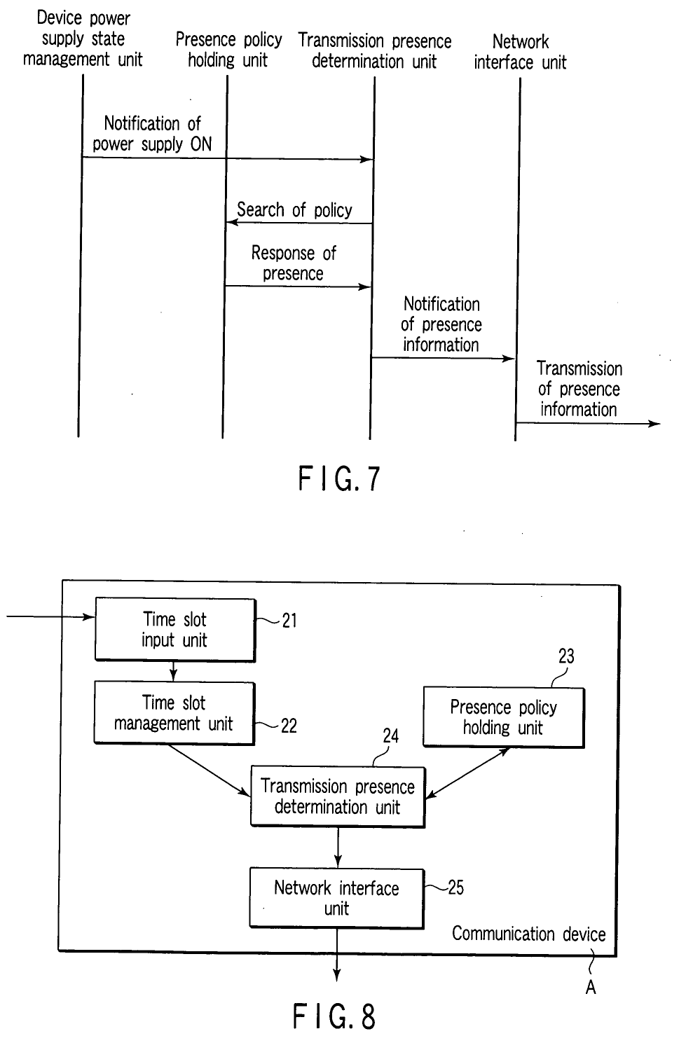

FIG. 6 is a block diagram showing the first example of the schematic arrangement of the communication device A. FIG. 7 is a view showing an example of the operation of the communication device A in the arrangement of the first example.

As shown in FIG. 6, the communication device A includes a device power supply state management unit 11, a presence policy holding unit 12, a transmission presence determination unit 13, and a network interface unit 14. The device power supply state management unit 11 and the presence policy holding unit 12 function as management means. The transmission presence determination unit 13 functions as a control means. The network interface unit 14 functions as a communication means.

The device power supply state management unit 11 manages a power supply state. For example, the device power supply state management unit 11 manages the power supply state for the display to which the video is output. The presence policy holding unit 12 holds and manages the transmission condition of the presence information. The transmission presence determination unit 13 controls transmission of the presence information via the network interface unit 14, on the basis of the power supply state managed by the device power supply state management unit 11 and the transmission condition of the presence information held by the presence policy holding unit 12. That is, the transmission presence determination unit 13 controls upload of the presence information for the presence server C.

Next, an example of transmission of the presence information used for operations shown in FIG. 7 in the communication device shown in FIG. 6 is described. The transmission presence determination unit 13 controls transmission of the presence information for the external device, e.g., presence server C, upon turn-on of power supply, and controls logon to the external device. The transmission presence determination unit 13 controls logoff from the external device after a predetermined time upon turn-off of power supply. Note that as the display shifts to a stand-by state in which power supply is not completely shut down, the transmission presence determination unit 13 controls logoff from the external device.

More specifically, as shown in FIG. 7, the device power supply state management unit 11 notifies the transmission presence determination unit 13 of the power supply ON state. In correspondence with this, the transmission presence determination unit 13 requires the presence policy holding unit 12 to search for a policy. In correspondence with this, the presence policy holding unit 12 responds to the transmission presence determination unit 13, and the transmission presence determination unit 13 notifies the network interface unit 14 of the presence information. In correspondence with this, the network interface unit 14 transmits the presence information.

FIG. 8 is a block diagram showing the second example of the schematic arrangement of the communication device A. As shown in FIG. 8, the communication device A includes a time slot input unit 21, a time slot management unit 22, a presence policy holding unit 23, a transmission presence determination unit 24, and a network interface unit 25. The time slot management unit 22 and the presence policy holding unit 23 function as management means. The transmission presence determination unit 24 functions as a control means. The network interface unit 25 functions as a communication means.

An example of the operation of the communication device A will be described below with reference to FIG. 8. The time slot input unit 21 inputs the time period designated by user operation. The time slot management unit 22 manages the designated time slot input by the time slot input unit 21. The presence policy holding unit 23 holds and manages the transmission condition of the presence information. The transmission presence determination unit 24 controls transmissions of the presence information via the network interface unit 25 on the basis of the designated time slot managed by the time period management unit 22 and the transmission condition of the presence information held by the presence policy holding unit 23. That is, the transmission presence determination unit 24 controls upload of the presence information for the presence server C.

The transmission presence determination unit 24 controls communication with the external device, e.g., presence server C, via the network interface unit 25, on the basis of the designated time period managed by the time slot management unit 22. For example, in the designated time slot, communication with the external device is rejected. In response to this communication rejection, for example, a message is stored in the external device, which is server. Alternatively, in response to a incoming call from the external device in the designated time slot, the transmission presence determination unit 24 superimposes the information indicating the incoming call on the output video, or displays the information indicating the incoming call on another display different from the display on which the video is output.

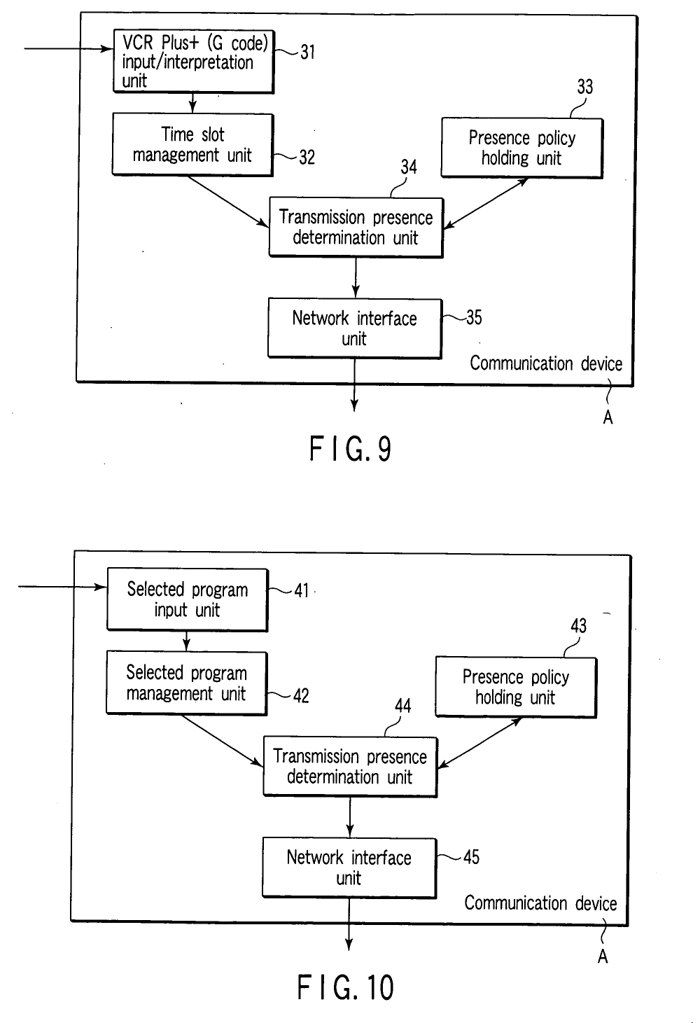

FIG. 9 is a block diagram showing the third example of the schematic arrangement of the communication device A. As shown in FIG. 9, the communication device A includes a VCR Plus+ (registered trademark) or a G code (registered trademark) input/interpretation unit 31, a time slot management unit 32, a presence policy holding unit 33, a transmission presence determination unit 34, and a network interface unit 35. The time slot management unit 32 and the presence policy holding unit 33 function as management means. The transmission presence determination unit 34 functions as a control means. The network interface unit 35 functions as a communication means.

An example of the operation of the communication device A will be described below with reference to FIG. 9. The VCR Plus+ input/interpretation unit 31 inputs and interprets a VCR Plus+. The time slot management unit 32 manages the broadcast time of the designated program on the basis of the VCR Plus+ input and interpreted by the VCR Plus+ input/interpretation unit 31. The presence policy holding unit 33 holds and manages the transmission condition of the presence information. The transmission presence determination unit 34 controls transmission of the presence information via the network interface unit 35 on the basis of the broadcast time of the designated program managed by the time slot management unit 32 and the transmission condition of the presence information held by the presence policy holding unit 33. That is, the transmission presence determination unit 34 controls upload of the presence information for the presence server C.

The transmission presence determination unit 34 controls communication with the external device, e.g., presence server C, via the network interface unit 35, on the basis of the broadcast time of the designated program managed by the time slot management unit 32. For example, in the broadcast time of the designated program, communication with the external device is rejected. In response to this communication rejection, for example, a message is stored in the external device, which is server. Alternatively, in response to a incoming call from the external device in the broadcast time of the designated program, the transmission presence determination unit 34 superimposes the information indicating the incoming call on the output video, or displays information indicating the incoming call on another display different from the display on which the video is output.

FIG. 10 is a block diagram showing the fourth example of the schematic arrangement of the communication device A. As shown in FIG. 10, the communication device A includes a selected program input unit 41, a selected program management unit 42, a presence policy holding unit 43, a transmission presence determination unit 44, and a network interface unit 45. The selected program management unit 42 and the presence policy holding unit 43 function as management means. The transmission presence determination unit 44 functions as a control means. The network interface unit 45 functions as a communication means.

An example of the operation of the communication device A will be described below with reference to FIG. 10. The selected program input unit 41 inputs a program selected in response to a user operation, e.g., program viewing reservation and program recording reservation. The selected program management unit 42 manages the broadcast time of the selected program input by the selected program input unit 41. The presence policy holding unit 43 holds and manages the transmission condition of the presence information. The transmission presence determination unit 44 controls transmission of the presence information via the network interface unit 45 on the basis of the broadcast time of the selected program managed by the selected program management unit 42 and the transmission condition of the presence information held by the presence policy holding unit 43. That is, the transmission presence determination unit 44 controls upload of the presence information for the presence server C.

The transmission presence determination unit 44 controls communication with the external device, e.g., presence server C, via the network interface unit 45, on the basis of the broadcast time of the selected program managed by the selected program management unit 42. For example, in the broadcast time of the selected program, communication with the external device is rejected. In response to this communication rejection, for example, a message is stored in the external device, which is server. Alternatively, in response to a incoming call from the external device in the broadcast time of the selected program, the transmission presence determination unit 44 superimposes the information indicating a incoming call on the output video, or displays information indicating the incoming call on another display different from the display on which the video is output.

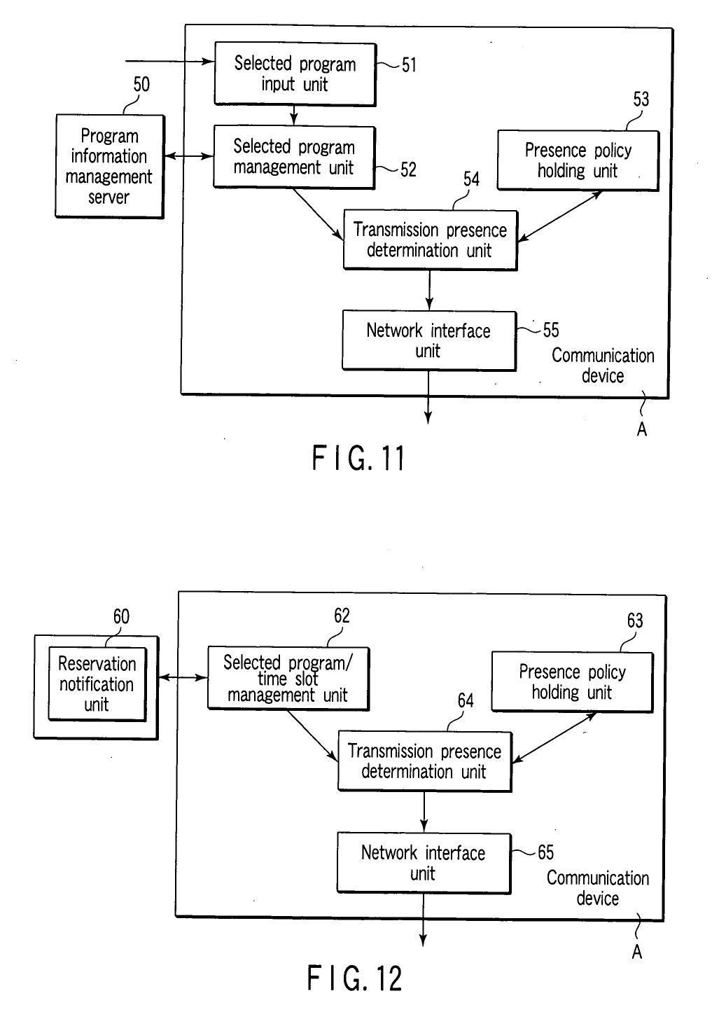

FIG. 11 is a block diagram showing the fifth example of the schematic arrangement of the communication device A. As shown in FIG. 11, the communication device A includes a selected program input unit 51, a selected program management unit 52, a presence policy holding unit 53, a transmission presence determination unit 54, and a network interface unit 55. The selected program management unit 52 and the presence policy holding unit 53 function as management means. The transmission presence determination unit 54 functions as a control means. The network interface unit 55 functions as a communication means.

An example of the operation of the communication device A will be described below with reference to FIG. 11. The selected program input unit 51 inputs the program selected by a user operation, e.g., program viewing reservation and program recording reservation. On the basis of the program information transmitted by a program information management server 50, the selected program management unit 52 manages the broadcast time of the selected program input by the selected program input unit 51. The program information management server 50 acquires the program information via a communication line, and supplies the acquired program information to the selected program management unit 52. Note that this program information is information, e.g., i-EPG (electronic program guide), including start and end times of the program for each program. The presence policy holding unit 53 holds and manages the transmission condition of the presence information. The transmission presence determination unit 54 controls transmission of the presence information via the network interface unit 55 on the basis of the broadcast time of the selected program managed by the selected program management unit 52 and the transmission condition of the presence information held by the presence policy holding unit 53. That is, the transmission presence determination unit 54 controls upload of the presence information for the presence server C.

The transmission presence determination unit 54 controls communication with the external device, e.g., presence server C, via the network interface unit 55, on the basis of the broadcast time of the selected program managed by the selected program management unit 52. For example, in the broadcast time period of the selected program, communication with the external device is rejected. In response to this communication rejection, for example, a message is stored in the external device, which is server. Alternatively, in response to a incoming call from the external device in the broadcast time of the selected program, the transmission presence determination unit 54 superimposes the information indicating the incoming call on the output video, or displays information indicating the incoming call on another display different from the display on which the video is output.

FIG. 12 is a block diagram showing the sixth example of the schematic arrangement of the communication device A. As shown in FIG. 12, the communication device A includes a selected program/time slot management unit 62, a presence policy holding unit 63, a transmission presence determination unit 64, and a network interface unit 65. The selected program/time slot management unit 62 and the presence policy holding unit 63 function as management means. The transmission presence determination unit 64 functions as a control means. The network interface unit 65 functions as a communication means.

An example of the operation of the communication device A will be described below with reference to FIG. 12. The selected program/time slot management unit 62 receives program recording reservation information from a reservation notification unit 60 of a recorder such as video recorder and DVD recorder, and manages the broadcast time of the program selected in accordance with this program recording reservation information. For example, the program recording reservation information is information based on the i-EPG (electronic program guide). The presence policy holding unit 63 holds and manages the transmission condition of the presence information. The transmission presence determination unit 64 controls transmission of the presence information via the network interface unit 65 on the basis of the broadcast time period of the selected program managed by the selected program/time period management unit 62 and the transmission condition of the presence information held by the presence policy holding unit 63. That is, the transmission presence determination unit 64 controls upload of the presence information for the presence server C.

The transmission presence determination unit 64 controls communication with the external device, e.g., presence server C, via the network interface unit 65, on the basis of the broadcast time of the selected program managed by the selected program/time slot management unit 62. For example, in the broadcast time of the selected program, communication with the external device is rejected. In response to this communication rejection, for example, a message is stored in the external device, which is server. Alternatively, in response to a incoming call from the external device in the broadcast time of the selected program, the transmission presence determination unit 64 superimposes the information indicating the incoming call on the output video, or displays information indicating the incoming call on another display different from the display on which the video is output.

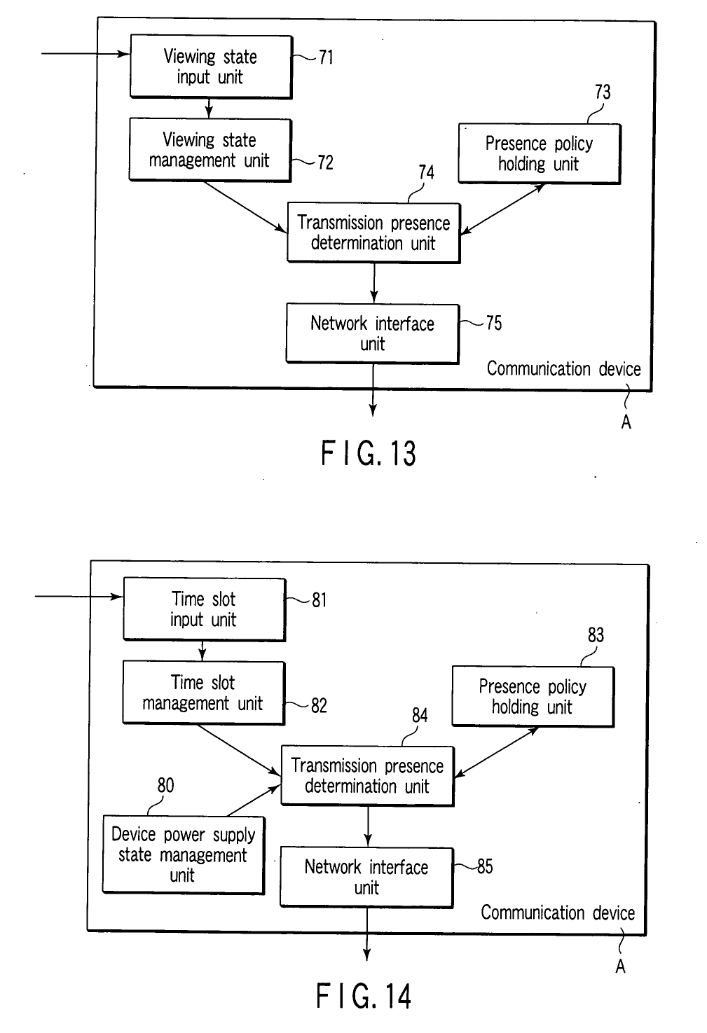

FIG. 13 is a block diagram showing the seventh example of the schematic arrangement of the communication device A. As shown in FIG. 13, the communication device A includes a viewing state input unit 71, a viewing state management unit 72, a presence policy holding unit 73, a transmission presence determination unit 74, and a network interface unit 75. The viewing state management unit 72 and the presence policy holding unit 73 function as management means. The transmission presence determination unit 74 functions as a control means. The network interface unit 75 functions as a communication means.

An example of the operation of the communication device A will be described below with reference to FIG. 13. The viewing state input unit 71 inputs the video output state (video output ON/video output OFF) of the video output device. The viewing state management unit 72 manages the video output state input by the viewing state input unit 71. The presence policy holding unit 73 holds and manages the transmission condition of the presence information. The transmission presence determination unit 74 controls transmission of the presence information via the network interface unit 75 on the basis of the video output state managed by the viewing state management unit 72 and the transmission condition of the presence information held by the presence policy holding unit 73. That is, the transmission presence determination unit 74 controls upload of the presence information for the presence server C.

The transmission presence determination unit 74 controls communication with the external device, e.g., presence server C, via the network interface unit 75, on the basis of the video output state managed by the viewing state management unit 72. For example, in the state of the video output ON, communication with the external device is rejected. In response to this communication rejection, for example, a message is stored in the external device (server). Alternatively, in response to a incoming call from the external device in the state of the video output ON, the transmission presence determination unit 74 superimposes the information indicating the incoming call on the output video, or displays information indicating the incoming call on another display different from the display on which the video is output.

Note that a video game can be applied in place of the video output. That is, it can be predicted that a video game is ON when the video output is ON. Hence, depending on whether the video game is ON, the user can control communication with the external device, and correspond to a incoming call from the external device. For example, in the state of the video game ON, communication with the external device is rejected. In response to this communication rejection, for example, a message is stored in the external device, which is server. Alternatively, in the stage of the game ON, information indicating a incoming call is superimposed on a screen in the state of the game ON, or information indicating the incoming call is displayed on another display different from the display on which the video is output.

FIG. 14 is a block diagram showing the eighth example of the schematic arrangement of the communication device A. As shown in FIG. 14, the communication device A includes a device power supply state management unit 80, a time slot input unit 81, a time slot management unit 82, a presence policy holding unit 83, a transmission presence determination unit 84, and a network interface unit 85. The device power supply state management unit 80, the time slot management unit 82, and the presence policy holding unit 83 function as management means. The transmission presence determination unit 84 functions as a control means. The network interface unit 85 functions as a communication means.

An example of the operation of the communication device A will be described below with reference to FIG. 14. The device power supply state management unit 80 manages the power supply state, e.g., the power supply state for the display on which the video is output. The time slot input unit 81 inputs the time slot designated by a user operation. The time slot management unit 82 manages the designated time slot input by the time slot input unit 81. The presence policy holding unit 83 holds and manages the transmission condition of the presence information. The transmission presence determination unit 84 controls transmission of the presence information via the network interface unit 85 on the basis of the power supply state managed by the device power supply state management unit 80, the designated time period managed by the time period management unit 82, and the transmission condition of the presence information held by the presence policy holding unit 83. That is, the transmission presence determination unit 84 controls upload of the presence information for the presence server C.

The transmission presence determination unit 84 controls transmission of the presence information for the external device, e.g., presence server C, upon turn-on of power supply. The transmission presence determination unit 84 also controls logoff from the external device upon turn-off of power supply. Furthermore, the transmission presence determination unit 84 controls communication with the external device, e.g., presence server C, via the network interface unit 85, on the basis of the designated time slot managed by the time slot management unit 82. For example, in the designated time slot, communication with the external device is rejected. In response to this communication rejection, for example, a message is stored in the external device, which is server. Alternatively, in response to a incoming call from the external device in the designated time slot, the transmission presence determination unit 84 superimposes the information indicating the incoming call on the output video, or displays information indicating the incoming call on another display different from the display on which the video is output.

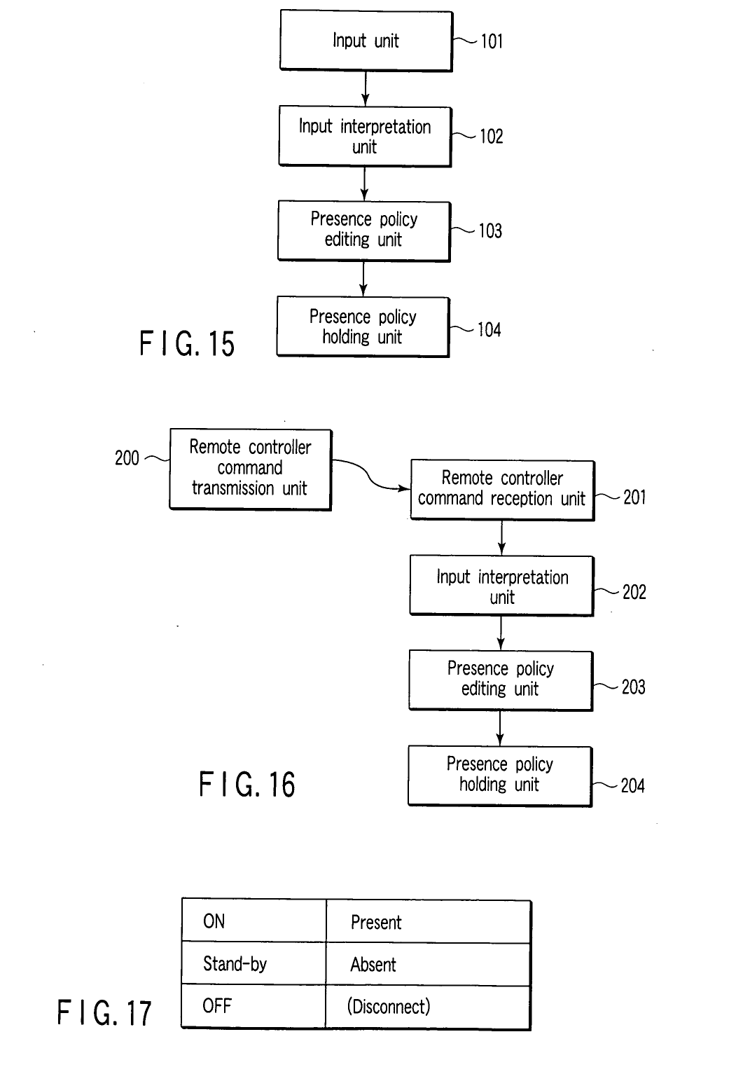

FIGS. 15 to 17 are diagrams for explaining a presence policy. FIG. 15 is a block diagram for explaining the first example of an editing process of the presence policy. FIG. 16 is a block diagram for explaining the second example of the editing process of the presence policy. FIG. 17 is a table showing an example of a presence policy table held by the presence policy holding unit.

As shown in FIG. 15, the communication device A includes an input unit 101, an input interpretation unit 102, a presence policy editing unit 103, and a presence policy holding unit 104. The information input by the input unit 101 is interpreted by the input interpretation unit 102. On the basis of the interpretation obtained by the input interpretation unit 102, the presence policy editing unit 103 edits the presence policy held by the presence policy holding unit 104.

As shown in FIG. 16, the communication device A includes a remote controller command transmission unit 200, a remote controller command reception unit 201, an input interpretation unit 202, a presence policy editing unit 203, and a presence policy holding unit 204. The command transmitted from the remote controller command transmission unit 200 is received by the remote controller command reception unit 201, and the received command is interpreted by the input interpretation unit 202. On the basis of the interpretation obtained by the input interpretation unit 202, the presence policy editing unit 203 edits the presence policy held by the presence policy holding unit 204.

As shown in FIG. 17, for example, in the presence policy table, the information indicating “present” is managed in correspondence with the power supply ON state of the communication device A. In the presence policy table, the information indicating “absent” is managed in correspondence with the stand-by state of the communication device A. Furthermore, in the presence policy table, no information is managed in correspondence with the power supply OFF state of the communication device A.

On the basis of this presence policy table, the information corresponding to a transmission of the presence information for the external device and a incoming call from the external device are controlled. For example, in correspondence with the power supply ON state of the communication device A, the presence information is transmitted to the external device to logon to the external device, the status information indicating “present” is transmitted, and the device responds to a incoming call from the external device. Also, in correspondence with the stand-by ON state of the communication device A, the status information indicating “absent” is transmitted to the external device. In correspondence with the power supply OFF state of the communication device A, the device logs off from the external device.

The communication device A may control the following operations.

For example, when a codec is used during recording the program, another codec is used to process incoming call's information.

Also, the communication device A manages whether the video game is ON, rejects a incoming call in the video game ON state, superimposes the information indicating the incoming call on a game screen, or displays the incoming call information on another display different from the display on which the video is output.

As described above, in the communication device A, the following effects can be obtained.

Since the communication device A includes the control button 1 (or the control button 1 on the remote controller 2) which controls transmission of the presence information and status information, transmission of the presence information and status information can easily be controlled.

Depending on the power supply state, e.g., power supply ON/stand-by/power supply OFF, the communication device A can control transmission of the presence information and status information.

The communication device A can also control transmission of the presence information and status information depending on the operation state, e.g., video output ON/game ON.

The communication device A can also reject a incoming call depending on the operation state, e.g., video output ON/game ON, and store the message on the server side. That is, the communication device A can cause the server to store the message, by a incoming call rejection setting depending on the operation state defined by the user.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A communication apparatus comprising:
a communication unit configured to communicate with an external device;
a management unit configured to manage a transmission condition of presence information; and
a control unit configured to control transmission of the presence information via the communication unit on the basis of the transmission condition of the presence information managed by the management unit.

2. An apparatus of claim 1, wherein
the management unit manages a power supply state, and
the control unit controls transmission of the presence information via the communication unit on the basis of the power supply state managed by the management unit.

3. An apparatus of claim 2, wherein the control unit transmits the presence information to an external server upon turn-on of the power supply, logs on to the external server, and logs off from the external server upon turn-off of the power supply.

4. An apparatus of claim 1, wherein
the management unit manages a video output state, and
the control unit controls communication with the external device via the communication unit on the basis of the video output state managed by the management unit.

5. An apparatus of claim 1, wherein
the management unit manages the video output state, and
in response to a incoming call from the external device via the communication unit in a video output ON state, the control unit superimposes information indicating the incoming call on a current output video, or outputs information indicating the incoming call to another unit different from the unit on which the video is output.

6. An apparatus of claim 1, wherein
the management unit manages a broadcast time of a designated program, and
the control unit controls communication with the external device via the communication unit on the basis of the broadcast time of the designated program managed by the management unit of the broadcast time.

7. An apparatus of claim 1, wherein
the management unit manages a broadcast time of a designated program, and
in response to a incoming call from the external device via the communication unit in the broadcast time of the designated program, the control unit superimposes information indicating the incoming call on a current output video, or outputs information indicating the incoming call to another unit different from the unit on which the video is output.

8. An apparatus of claim 6, wherein the management unit manages the broadcast time of the designated program on the basis of an electronic program guide.

9. An apparatus of claim 7, wherein the management unit manages the broadcast time of the designated program on the basis of an electronic program guide.

10. An apparatus of claim 6, wherein the management unit manages the broadcast time of the designated program on the basis of recording reservation information corresponding to an electronic program guide.

11. An apparatus of claim 7, wherein the management unit manages the broadcast time of the designated program on the basis of recording reservation information corresponding to an electronic program guide.

12. A communication method for a system in which a communication device and a server mutually recognize their presence by exchanging a logical message, comprising:
managing a transmission condition of presence information; and
controlling transmission of the presence information on the basis of the transmission condition of the managed presence information.
